(19) United States
(12) Patent Application Publication
(10) Pub. No.: US 2016/0071068 A1
(43) Pub. Date: Mar. 10, 2016

(54) Critical Path Scheduling with Early Finish Sets

(71) Applicant: Bernard Ertl, Houston, TX (US)

(72) Inventor: Bernard Ertl, Houston, TX (US)

(21) Appl. No.: 14/479,808

(22) Filed: Sep. 8, 2014

(51) Int. Cl. G06Q 10/10; G06Q 10/06

(52) U.S. Cl. CPC G06Q 10/1097; G06Q 10/063114

(57) ABSTRACT

Systems, computer-implemented methods and non-transitory computer-readable storage medium are provided for updating a project schedule by automatically generating “earliest finish from a group” relationships between tasks in projects that follow the critical path method. Upon the determination that at least one of the relationships is an earliest finish relationship with a successor task, a forward pass and backward pass for the project schedule may be calculated using the determined earliest finish relationships and ignoring all non-earliest finish relationships within all the earliest finish sets.

### BACKGROUND

Effective project management requires the development of a realistic plan and a clear communication of the plan from the beginning to the end of the project. The critical path method of scheduling (or “CPM”) is the fundamental tool used to develop and communicate project plans. CPM scheduling calculations can be applied in any project that has a number of individual and interdependent tasks.

In order to use the CPM, a model of the project is constructed. The model includes but is not limited to a list of all activities or tasks required to complete the project, the duration or time to complete each task and the dependencies between the tasks. The CPM may involve graphically depicting or diagramming how a task is related to one or more other tasks. A critical path is defined as a sequence of activities that add up to the longest overall duration. It is the shortest time possible to complete the project. Any delay of a task on the critical path directly impacts the planned project completion date. CPM calculations involve the use of data such as the number of project resources, duration, predecessor and successor relationships, etc. as input variables to: determine the earliest and latest possible dates that each task can start and finish without impacting the duration of the project (also known as early start (ES), early finish (EF), late start (LS), late finish (LF)); determine the longest path of planned tasks to the end of the project; determine “critical” tasks on the longest path, prioritize tasks for effective management; determine the “float” (that is, the amount of time that a task can be delayed without causing a delay to subsequent tasks and the project completion date); and to shorten the planned critical path of a project. Shortening the planned critical path of a project may involve pruning critical path activities, performing more tasks in parallel, or shortening the durations of critical path tasks by adding resources (or utilizing a different method, equipment or tools to accomplish the work).

### SUMMARY

Methods, non-transitory computer-readable storage media and systems for updating a project schedule are disclosed herein.

According to an embodiment, a method for updating a project schedule includes designating one or more relationships in the project schedule for inclusion in one or more earliest finish sets, wherein each of the relationships designated for inclusion in the one or more earliest finish sets comprises a common successor task; determining automatically, by a project management system executing on a processing device, during the calculation of a forward pass for the project schedule, which of the designated relationships in each of the one or more earliest finish sets is an earliest finish relationship with the common successor task; and upon the determination of the designated earliest finish relationships in each of the earliest finish sets, automatically calculating, by the processing device, a forward pass for the project schedule using the determined earliest finish relationship(s).

The determining of the earliest finish relationship in each of the earliest finish sets further involves automatically analyzing, by the processing device, each of the earliest finish sets to identify the designated relationship in the corresponding earliest finish set that has a least impact on at least one of an early start date/time and an early finish date/time of the common successor task. The determination of the earliest finish relationship may be an iterative process which involves determining the earliest finish relationship in each of the earliest finish sets, wherein an analysis is automatically performed, by the processing device, to determine an updated (or current) earliest finish relationship for the corresponding earliest finish set by selecting the designated relationship which currently, or at the time of conducting the analysis, has a least impact on at least one of an early start date/time and an early finish date/time of the common successor task.

The project schedule can be analyzed to determine relationships identifying predecessor tasks for and successor tasks to each of the tasks.

Designating the plurality of relationships for inclusion in one or more earliest finish sets further involves the step of assigning a first indicator to identify each of the relationships for inclusion in the one or more earliest finish sets. A first attribute may be assigned to identify the each of the designated relationships for inclusion in the one or more earliest finish sets. The designated relationships may be further grouped into the one or more earliest finish sets.

The project schedule may be updated by processing device by automatically calculating a forward pass for the project schedule to determine each task's early start and early finish. When calculating the forward pass, upon the determination that an earliest finish set has more than one relationship in it, the processing device can automatically assign a second indicator to identify the determined earliest finish relationship within that set. A second attribute may be assigned to identify the earliest finish relationship in each of the earliest finish sets.

The project schedule may be updated by the processing device by automatically calculating a backward pass for the project schedule to determine each task's late start and late finish based on the determined earliest finish relationship in each of the earliest finish sets.

The calculation of the forward pass and/or the backward pass for the project schedule ignores or disregards any non-earliest finish relationship(s) in each earliest finish set.

The methods for the embodiments of the present invention may be performed by a processing device using computer usable program code, which may be located in a memory such as, for example, main memory, ROM, or in one or more peripheral devices for example.

In another embodiment, a non-transitory computer-readable storage medium includes instructions that, when executed by a processing device, cause the processing device to perform a set of operations comprising: providing, by a user interface module, an interface for designating one or more relationships in a project schedule for inclusion in one or more earliest finish sets, wherein each of the relationships designated for inclusion in the one or more earliest finish sets comprises a common successor task; determining automatically, by a project management system executing on the processing device, during the calculation of a forward pass for the project schedule, which of the designated relationships in each of the one or more earliest finish sets is the earliest finish relationship with the common successor task; and automatically calculating, by the processing device, a forward pass for the project schedule using the determined earliest finish relationship(s) and ignoring all non-earliest finish relationships in each of the earliest finish sets.

Another embodiment relates to a project management system comprising: a memory to store instructions; and a processing device, coupled to the memory, wherein the processing device is to execute the instructions to perform operations comprising: providing, by a user interface module, an interface for designating one or more relationships in a project schedule for inclusion in one or more earliest finish sets, wherein each of the relationships designated for inclusion in the one or more earliest finish sets comprises a common successor task; determining automatically, during the calculation of a forward pass for the project schedule, which of the designated relationships in each of the one or more earliest finish sets is the earliest finish relationship with the common successor task; and, automatically calculating a forward pass for the project schedule using the determined earliest finish relationship(s) and ignoring all non-earliest finish relationships in each of the earliest finish sets.

The aforementioned advantages of the invention, as well as additional advantages thereof, are more fully described by the detailed description of exemplary embodiments and the accompanying drawings.

### BRIEF DESCRIPTION OF THE DRAWINGS

FIG. 1 is a diagrammatic view of a system for updating a project schedule according to one embodiment.

FIG. 2 is a diagrammatic view according to one implementation illustrating the determination of earliest finish relationships.

FIG. 3 is a flow diagram illustrating an exemplary method for updating a project schedule by the determination of an earliest finish relationship.

FIGS. 4A and 4B are screen displays illustrating exemplary embodiments for displaying the designation of earliest finish sets.

### DETAILED DESCRIPTION

In this document, the term “CPM” includes all variations of the CPM including the arrow diagramming method (or “ADM”) and the precedence diagram method (or “PDM”). Both the ADM and PDM are graphical methods of depicting the sequence of tasks in a project. PDM can be represented as a network of arrows and nodes where the nodes represent tasks and the arrows indicate dependencies between the tasks. The diagram can also depict the duration of each task and time lags between the starts and finishes of related tasks. The CPM (and its PDM variation) has been used in almost all industries, including the construction industry.

Currently, project management software applications that utilize the CPM method cannot schedule successor tasks based on the earliest finish from a group of relationships. For example, consider a refinery that has two pumps, Pump A and Pump B and an associated compressor C that is offline for maintenance. In an ideal scenario, testing the associated compressor can be commenced as soon as one of Pump A or Pump B is available. The tasks associated may include the following:

### Pump A (A)

Task 1—Open and clean—2 days
Task 2—Inspect—2 hours
Task 3—Repair per inspection—to be determined
Task 4—Close/Finish—1 day

### Pump B (B)

Task 1—Open and clean—2 days
Task 2—Inspect—2 hours
Task 3—Repair per inspection—to be determined
Task 4—Close/Finish—1 day

### Compressor (C)

Task 1—Test as soon as Pump A or Pump B is available.

Ideally, work on Pump A and Pump B is started simultaneously. However, since the duration of Task 3 (for both Pump A and Pump B) is unknown, there is a possibility that the work on both pumps may not be finished simultaneously. As mentioned earlier, in order to avoid downtime, the test on Compressor C can start immediately when work on the first of Pump A or Pump B is finished. Thus, Compressor C has two predecessor tasks, [A(task 4), B(task 4)] and work on Compressor C can start at the completion of the earliest of those predecessors. With existing CPM-based scheduling software systems, the user, typically, a project manager/planner/scheduler has to manually create/add or edit a single (latest predecessor) relationship, in the software, from Pump A or Pump B (whichever is currently scheduled to finish first) to the Compressor C as the schedule is updated (throughout the lifecycle of the project) in order to ensure that the Compressor C starts at the earliest opportunity.

As can be seen from the above example with only two pumps and a compressor, this is an iterative process and involves manually tracking and updating the schedule at a task-by-task level. This process can become increasingly more complex and challenging as the project grows in scale and involves various interdependent tasks. Unwanted errors may be introduced into the schedule. Also, the user may have limited time for analyzing and updating the schedule. Consequently, there is a need for an invention that can resolve these issues.

In accordance with one or more embodiments, systems, computer-implemented methods and non-transitory computer-readable storage medium are provided for updating a project schedule by automatically creating “earliest finish from a group” relationships between tasks in projects that follow the CPM. This can facilitate correct scheduling and management of complex, real world projects.

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As used in this document, the term “project” is meant to include an enterprise that involves planning and creation of one or more tasks to achieve a desired goal. Projects can be measured based upon time and/or other factors. As used in this document, the term “task” is meant to include an activity or an individual unit of work that is performed as part of an overall project. As used herein, a task may further encompass any block of time that can be scheduled (or is subject to sequencing/scheduling relationships), including, but not limited to, subdivisions of activities/tasks for individual resources. A task can be a line item in a project management software. A task can have multiple resources assigned to it and each resource can maintain its own time estimate and is potentially scheduled individually. As used in this document, the term “attribute” includes a feature, reference or key that can describe a data element such as a task or a relationship or a grouping of tasks or relationships. As used in this document, the terms “predecessor” and “successor” include two types of dependent tasks that belong to the same project and that are sequenced or scheduled under dependency rules. As used herein, a predecessor task determines the start or finish date of its successor task. A “set” as used herein, refers to any positive whole number of items including one. As used in this document, the term “relationship” includes identification of the sequencing/scheduling between a predecessor task and a successor task.

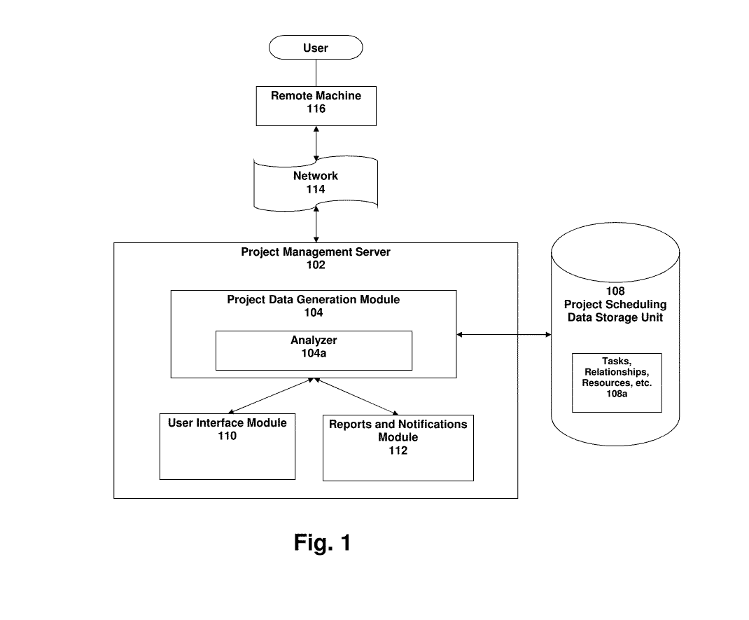

FIG. 1 is a diagram of one embodiment of the automated system for updating a project schedule. The system includes a project management server 102 and a project scheduling data storage unit 108 for saving project data. The project management server 102 can be accessible to any number of user machines and users through a network 114. The network 114 can be local area network (LAN), such as an intranet within a company, a wide area network (WAN), such as the Internet or similar communication system. The network 114 can include any number of networking and computing devices including any number of wired and wireless devices. The network may include connections, such as wire, wireless communication links, or fiber optic cables.

The project management server 102 includes a project data generation module 104, a user interface module 110, a reports and notification module 112 and similar components. This division of functionality is presented merely by way of example for the sake of clarity. One skilled in the art would understand that the functionality described could be combined into a monolithic component or sub-divided into any similar combination of components.

The user interface module 110 can interface with any of the other modules or components of the project management server 102 including the project data generation module 104 and the reports and notification module 112 to generate a project scheduling interface to be utilized by a user, such as, a project planner or project manager. The user interface module 110 can provide a graphical user interface or command line interface for remote machine 116 over the network 114. Any number of remote machines may be used to access the user interface module 110. The user interface module 110 can be a web-based interface such as a web server or similar specialized interface to interact with the client on remote machines. Remote machine 116 can be any type of computing device including desktop computers, laptop computers, handheld computers or similar computing device. The user interface provided by the user interface module 110 can be accessed by general purpose browsers or specialized applications. The user interface module 110 interfaces the project management server 102 with the remote machines 116 by making available the functionality of the project data generation module 104 and the reports and notification module 112.

Instructions for the project scheduling software and project-related data files may be stored in the project scheduling data storage unit 108 and loaded into memory for execution by a processing unit (not shown). A communication unit, such as modem or network adapter (not shown), may include one or more devices used to transmit and receive data.

The project data generation module 104 may further include an analyzer 104a. The analyzer 104a can monitor and analyze information on the project scheduling data 108a stored in the project scheduling data storage unit 108. Project scheduling data 108a may include details about the tasks in the project, the relationship(s) between the tasks, the resources required to complete the tasks, the duration of each task, the deadlines associated with the tasks and/or other pertinent data. The project scheduling data 108a is analyzed by the project data generation module 104 to determine associated task relationships that are available. The project scheduling data storage unit 108 can be a local storage unit or a remote storage unit. The project scheduling data storage unit 108 may be a magnetic storage unit, optical storage unit, solid state storage unit or similar storage unit. The project scheduling data storage unit 108 can be a monolithic device or a distributed set of devices. The project scheduling data 108a can be stored in a database, file system or similar data storage system.

The analyzer 104a can continually and automatically retrieve and analyze the project scheduling data 108a, in a real time or substantially real time basis, to determine whether one or more tasks in the project have a common successor task. When one or more tasks are identified as sharing a common successor task, a user can assign a first attribute to the relationships that connect the identified predecessor tasks that share the common successor task. The user can further group relationships connecting predecessor tasks that share a common successor task to create one or more “earliest finish set(s)” (or “EFS”). An EFS, as described above, can include one or more relationships that share a common successor task. A successor task could be associated with one or more of the earliest finish sets.

The analyzer 104a can examine each of the earliest finish sets to identify a relationship from each of the earliest finish sets that finishes earliest. For example, the analyzer can automatically examine EFS 1 and EFS 2 to identify a relationship from each of EFS 1 and EFS 2 that finishes earliest. As used herein, the term “finishes earliest” means the task relationship that has the least impact on the early start or early finish of the successor task. The PDM relationships can affect either the early start (finish to start [FS], start to start [SS]) or early finish (finish to finish [FF, start to finish [SF]) of the successor task. The analyzer 104a can generate a second attribute and associate it with each of the earliest finish relationships in each of the earliest finish sets. For example, the analyzer can assign identifiers EFR1 and EFR2 corresponding to the earliest finish relationships in EFS 1 and EFS 2. When calculating the forward pass (early starts, early finishes) of the schedule, when considering which predecessor relationship can drive the early start for a given task, the analyzer 104a can process all predecessor relationships in EFS 1 and EFS 2 to select only EFR1 and EFR2. The analyzer 104a may ignore or disregard all non-EFR relationships in EFS 1 and EFS 2. Also, when the analyzer 104a calculates the backward pass (late starts, late finishes), only the determined EFR1 and EFR2 may be considered.

The reports and notifications module 112 interfaces with the task relationship generation module 112. Reports and notifications can be generated to inform one of more users of the updated schedule. The reports may be in the form of Gantt charts that display the EFRs and normal relationships. These notifications can be displayed in a report upon user request (using the user interface module 110). These notifications can also be in the form of automatic notices that get sent in the form of an email, alert, and/or logged to a database for further review by one or more users.

Those of ordinary skill in the art will appreciate that other internal hardware or peripheral devices, such as flash memory, equivalent non-volatile memory, or optical disk drives and the like, may be used in addition to or in place of the hardware described. Moreover, the system may take the form of any of a number of different data processing systems including client computing devices, server computing devices, a tablet computer, laptop computer, telephone or other communication device, a personal digital assistant (PDA), or the like. In some illustrative examples, the system may be a portable computing device which is configured with flash memory to provide non-volatile memory for storing operating system files and/or user-generated data, for example. Essentially, the system may be any known or later developed data processing system without architectural limitation.

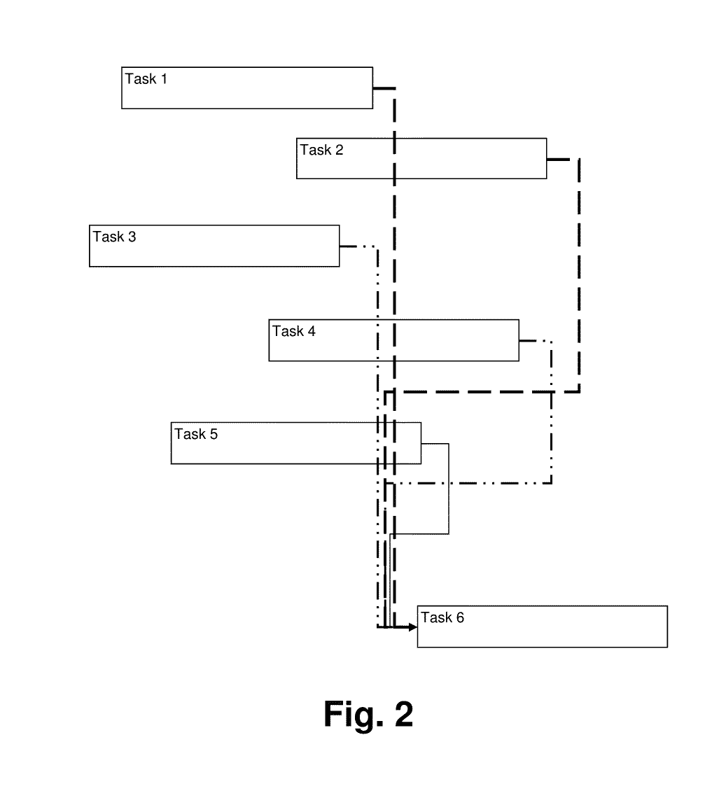

FIG. 2 is graphical representation according to an embodiment. The relationships from Tasks 1 and 2 to Task 6 can be associated with a first EFS. The relationships in the first EFS can be denoted with heavy dashed lines. The relationships from Task 3 and Task 4 can be associated with a second EFS. The relationships in the second EFS can be denoted with lighter lines of dashes and dots. The relationship from Task 5 to Task 6 is not in any EFS. This can be denoted with a solid line.

When calculating the early start (ES) of Task 6, the relationship from Task 1 to Task 6 can be identified as the EFR for the first EFS comprising of relationships from Tasks 1 and 2 to Task 6 because it finishes earlier than the relationship from Task 2 to Task 6.

Similarly, the relationship from Task 3 to Task 6 can be identified as the EFR for the second EFS comprising of relationships from Tasks 3 and 4 to Task 6 because it finishes earlier than the relationship from Task 4 to Task 6.

Accordingly, in effect, only the predecessor relationships from Tasks 1, 3 and 5 are considered when calculating the early start for Task 6. In this case, the relationship from Task 5 is the latest finish. Therefore, the driver for Task 6's early start is Task 5.

Further, when calculating the backwards pass (late start, late finish), only the EFR relationships from the first and second EFS sets (relationships from Tasks 1 and 3 to Task 6) may be considered (from those sets) aside from Task 5.

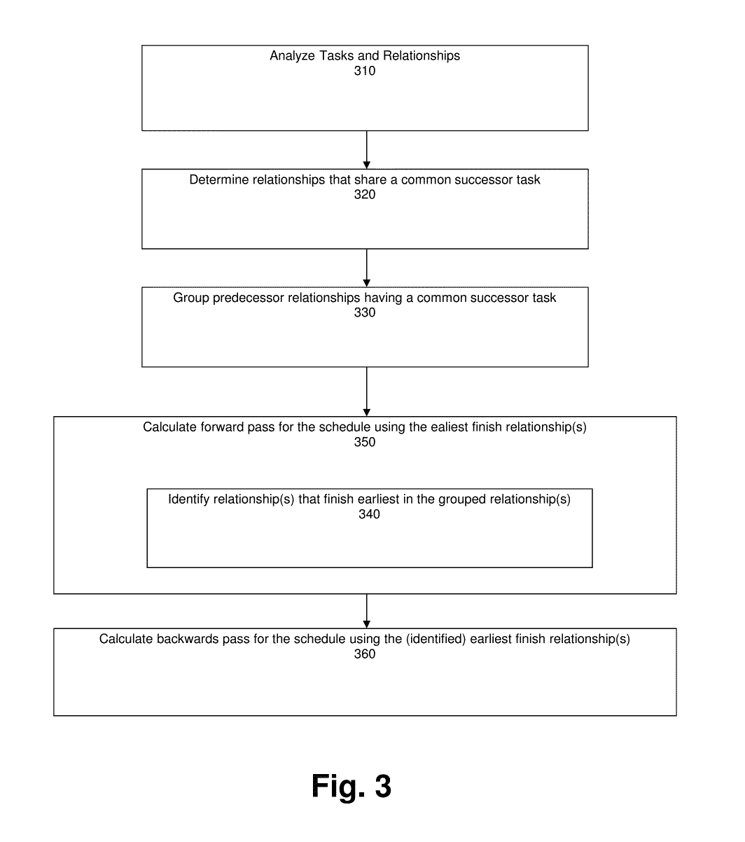

FIG. 3 is an example flowchart outlining an example operation for performing automatic EFS generation in accordance with one illustrative embodiment. Although not shown in FIG. 3, the operation can start with a request being received to generate an updated schedule. This request may be generated in response to a user input requesting an updated schedule, or it may be automatically generated in response to a detected change in the status of one or more tasks, relationships or other project data (elements). Irrespective of the origin of the request, in response to receiving this request, the tasks in the project scheduling data are analyzed 310. Other pertinent information such as resources, deadlines, etc. are also retrieved and analyzed.

The tasks and their relationships can be analyzed to determine or identify if two or more tasks share a common successor task 320. When one or more tasks are identified as sharing a common successor task, a user can assign a first attribute to the relationships that connect the identified predecessor tasks that share the common successor task. The user can further group relationships connecting predecessor tasks that share a common successor task to create one or more “earliest finish set(s)” (or “EFS”) 330.

Once the relationships connecting the predecessor tasks to each common successor task are grouped into earliest finish sets, the project management system, according to an embodiment, which executes on a processing device, automatically applies a pre-programmed algorithm or rule set to identify an earliest finish relationship while calculating the forward pass. The term “algorithm” can encompass an algorithm or a rule set. The predecessor tasks related to the relationships in each EFS are further analyzed to identify the predecessor task that finishes earliest 340. The EFS relationship related to the predecessor task that finishes earliest is assigned a second attribute to identify its earliest finish relationship (“EFR”) with the successor task 340. A backward pass for the schedule is also calculated using the identified earliest finish relationship(s) 360.

The schedule can be updated by calculating the forward and backward pass. Only the EFR in any given EFS is considered when calculating the forward and/or backward pass 350, 360. The determination of the EFR is an iterative process. For instance, while calculating the forward pass for the project schedule to determine the early start date or times and early finish dates or times for each task, whenever processing a relationship with an EFS, an analysis is automatically performed by the processing device to determine a current EFR for the EFS by selecting the relationship which currently (that is, when the analysis is conducted) has the least impact on the common successor task and exclusively denoting the EFR status within the corresponding EFS. As before, only the EFRs are processed by the forward pass calculation. Due to the complexity of the calculations that may be involved in the implementation of the embodiment of the invention, it may be beneficial to implement it using parallel processors or other means for increasing processing ability.

Although not shown, information on the EFS/EFR may be displayed to an authorized user for approval and/or editing. The EFS/EFR may then be stored in a storage unit/database for later retrieval and use when updating or reporting the schedule. The embodiments of the invention provide an efficient method for scheduling a project.

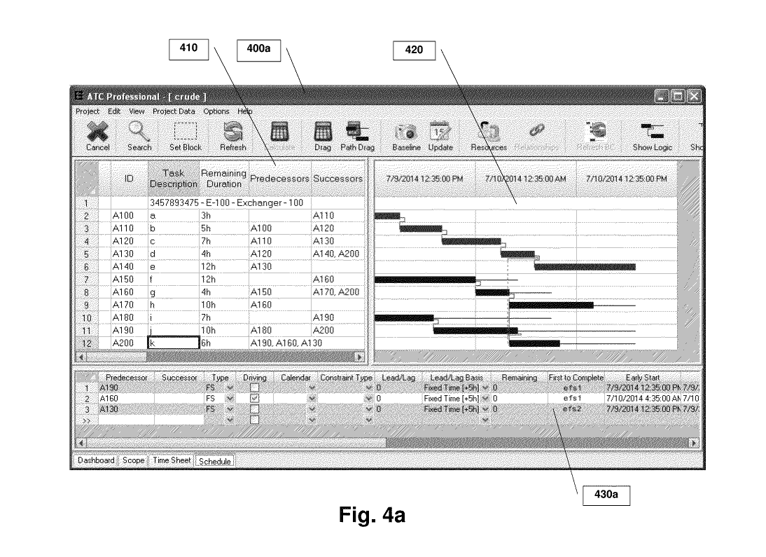

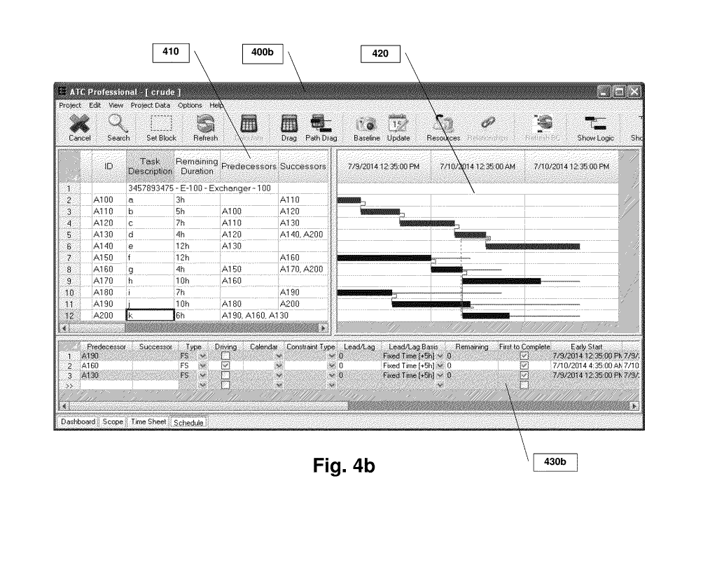

FIGS. 4A and 4B depict exemplary screen displays 400a, 400b for designating an earliest finish set. The user can define various tasks in an editing grid 410 shown in the top left pane. In these examples, Record/line 1 can include a summary or header. Records/lines 2-10 can include tasks with generic descriptions, shown here using identifiers a,b,c,d,e etc. Each task can be assigned a unique identifier (“ID”). Each task is further associated with a specific duration. Furthermore, each of the tasks may be associated with predecessor and/or successor tasks (for example, a list of unique identifiers for each).

A graphic representation of the schedule can be displayed in the top right pane 420. For example, a Gantt chart format can be used to display the schedule. As shown, EFRs and normal relationships can be displayed by solid lines. Non-active EFS relationships can be displayed with dashed or dotted lines. The EFS and EFR status of relationships could also be highlighted using color coding, different line thicknesses, symbols or other means.

Relationships can be designated on the bottom pane 430a, 430b. As shown, relationships attached to the task highlighted in the editing grid 410, for example, task 12, can be designated. The bottom pane 430a, 430b allows the user to edit details for each relationship. The user can identify a relationship as being part of one or more EFS (as shown in FIG. 4A using identifiers efs1 and efs2) in the “First to Complete” column.

As shown in bottom pane 430b, a checkbox (or, alternately, yes/no selection boxes/radio buttons, etc.) can be used to identify the EFS relationship(s) attribute(s). A task, such as task 12, can have just one EFS as its predecessor. Alternately, as shown in bottom pane 430a, the “First to Complete” column can accept a unique identifier for the EFS. The identifier can be alphanumeric. As shown, a task, such as task 12, can then have more than one EFS as its predecessor.

Advantageously, color coding (or, an additional attribute column) can be used to identify, to the user, the determined EFR (for example, in a white background) and non-active EFS relationships (for example, in a gray background).

Unless specifically stated otherwise as apparent from the above discussion, it is appreciated that throughout the description, discussions utilizing terms such as “determining,” “assigning,” “associating,” “analyzing,” “displaying,” “presenting,” or the like, refer to the actions and processes of a computer system, or similar electronic computing device that manipulates and transforms data represented as physical (electronic) quantities within the computer system's registers and memories into other data similarly represented as physical quantities within the computer system memories, registers or other such information storage, transmission or display devices.

As will be appreciated by one skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

No limitation with regard to the described aspects or embodiments of the present invention is intended. Many modifications to the depicted embodiments may be made without departing from the spirit and scope of the present invention. For example, it may be possible to only consider the EFR during the calculation of the forward pass while ignoring the EFR and using a different heuristic for determining the backward pass. Accordingly, the foregoing description is intended to be illustrative rather than restrictive. The invention described hereinabove is defined by the appended claims and all changes to the invention that fall within the meaning and the range of equivalency of the claims are embraced within their scope.

1. A method for updating a project schedule, the method comprising:
designating one or more relationships in the project schedule for inclusion in one or more earliest finish sets, wherein each of the relationships designated for inclusion in the one or more earliest finish sets comprises a common successor task;
determining automatically, by a project management system executing on a processing device, while calculating a forward pass for the project schedule, which of the designated relationships in each of the one or more earliest finish sets is an earliest finish relationship with the common successor task; and
upon the determination of which of the designated relationships in each of the earliest finish sets is an earliest finish relationship, automatically calculating, by the processing device, the forward pass for the project schedule using the determined earliest finish relationships.

2. The method according to claim 1, further comprising analyzing the project schedule to determine a scheduling relationship between one or more predecessor tasks and one or more successor tasks.

3. The method according to claim 1, wherein the designating the plurality of relationships for inclusion in one or more earliest finish sets further comprises assigning a first indicator to identify each of the relationships for inclusion in the one or more earliest finish sets.

4. The method according to claim 3, further comprising assigning a first attribute to identify the each of the relationships for inclusion in the one or more earliest finish sets.

5. The method according to claim 1, further comprising grouping the designated relationships into the one or more earliest finish sets.

6. The method according to claim 1, wherein upon the determination that at least one of the designated relationships in each of the earliest finish sets is an earliest finish relationship, automatically assigning, by the processing device, a second indicator to identify the determined earliest finish relationship.

7. The method according to claim 6, further comprising assigning a second attribute to identify the earliest finish relationship in each of the earliest finish sets.

8. The method according to claim 1, further comprising automatically calculating, by the processing device, a backward pass for the project schedule based on the determined earliest finish relationship in each of the earliest finish sets.

9. The method according to claim 8, wherein the calculation of the forward pass and/or the backward pass for the project schedule comprises ignoring all non-earliest finish relationship in each of the earliest finish sets.

10. The method according to claim 1, wherein the determining the earliest finish relationship in each of the earliest finish sets further comprises automatically analyzing, by the processing device, each of the earliest finish sets to identify the designated relationship in the corresponding earliest finish set that has a least impact on at least one of an early start date/time and an early finish date/time of the common successor task.

11. The method according to claim 1, further comprising iteratively determining the earliest finish relationship in each of the earliest finish sets, wherein an analysis is automatically performed, by the processing device, to determine an updated earliest finish relationship for the corresponding earliest finish set by selecting the designated relationship which currently has a least impact on at least one of an early start date/time and an early finish date/time of the common successor task.

12. A non-transitory computer-readable storage medium including instructions that, when executed by a processing device, cause the processing device to perform a set of operations comprising:
providing, by a user interface module, an interface for designating a plurality of relationships in a project schedule for inclusion in one or more earliest finish sets, wherein each of the relationships designated for inclusion in the one or more earliest finish sets comprises a common successor task;
determining automatically, by a project management system executing on the processing device, while calculating a forward pass for the project schedule, which of the designated relationships in each of the one or more earliest finish sets is an earliest finish relationship with the common successor task; and
upon the determination of which of the designated relationships in each of the earliest finish sets is an earliest finish relationship, automatically calculating, by the processing device, the forward pass for the project schedule using the determined earliest finish relationships and ignoring all non-earliest finish relationships within each of the earliest finish sets.

13. The non-transitory computer-readable storage medium according to claim 12, further comprising instructions, that when executed by the processing device, automatically calculates a backward pass for the project schedule based on the determined earliest finish relationship in each of the earliest finish sets.

14. The non-transitory computer-readable storage medium according to claim 12, further comprising instructions, that when executed by the processing device, iteratively determines the earliest finish relationship in each of the earliest finish sets, wherein an analysis is automatically performed, by the processing device, to determine an updated earliest finish relationship for the corresponding earliest finish set by selecting the designated relationship which currently has a least impact on at least one of an early start date/time and an early finish date/time of the common successor task.

15. The non-transitory computer-readable storage medium according to claim 12, wherein the determining the earliest finish relationship in each of the earliest finish sets further comprises instructions, that when executed by the processing device, automatically analyzes each of the earliest finish sets to identify the designated relationship in the corresponding earliest finish set that has a least impact on at least one of an early start and an early finish of the common successor task.

16. A project management system comprising:
a memory to store instructions; and
a processing device, coupled to the memory, wherein the processing device is to execute the instructions to perform operations comprising:
providing, by a user interface module, an interface for designating one or more relationships in a project schedule for inclusion in one or more earliest finish sets, wherein each of the relationships designated for inclusion in the one or more earliest finish sets comprises a common successor task;
determining automatically, while calculating a forward pass for the schedule, whether at least one of the designated relationships in each of the one or more earliest finish sets is an earliest finish relationship with the common successor task; and
upon the determination that at least one of the designated relationships in each of the earliest finish sets is an earliest finish relationship, automatically calculating a forward pass for the project schedule using the determined earliest finish relationships and ignoring all non-earliest finish relationships within each of the earliest finish sets.

17. The project management system according to claim 16, wherein the processing device further executes the instructions for analyzing the project schedule to determine one or more predecessor tasks and one or more successor tasks.

18. The project management system according to claim 16, wherein the processing device further executes the instructions for automatically calculating, by the processing device, a backward pass for the project schedule based on the determined earliest finish relationship in each of the earliest finish sets.

19. The project management system according to claim 16, wherein the determining the earliest finish relationship in each of the earliest finish sets further comprises instructions, that when executed by the processing device, automatically analyzes each of the earliest finish sets to identify the designated relationship in the corresponding earliest finish set that has a least impact on at least one of an early start date/time and an early finish date/time of the common successor task.

20. The project management system according to claim 16, further comprising instructions for iteratively determining the earliest finish relationship in each of the earliest finish sets, wherein an analysis is automatically performed, by the processing device, to determine an updated earliest finish relationship for the corresponding earliest finish set by selecting the designated relationship which currently has a least impact on at least one of an early start date/time and an early finish date/time of the common successor task.
